(19) United States
(12) Patent Application Publication
(10) Pub. No.: US 2023/0395799 A1
(43) Pub. Date: Dec. 7, 2023

(54) POSITIVE ELECTRODE ACTIVE MATERIAL FOR FLUORIDE ION BATTERY AND FLUORIDE ION BATTERY

(71) Applicant: TOYOTA JIDOSHA KABUSHIKI KAISHA, Toyota-shi (JP)

(72) Inventor: Kousuke NOI, Uji-shi (JP)

(73) Assignee: TOYOTA JIDOSHA KABUSHIKI KAISHA, Toyota-shi (JP)

(21) Appl. No.: 18/129,971

(22) Filed: Apr. 3, 2023

(30) Foreign Application Priority Data
Jun. 1, 2022 (JP) 2022-089854

(51) Int. Cl. H01M 4/58; C01G 49/12; H01M 4/02

(52) U.S. Cl. CPC H01M 4/5815; C01G 49/12; H01M 2004/028; C01P 2006/40

(57) ABSTRACT

A positive electrode active material for a fluoride ion battery, and a fluoride ion battery, having reduced irreversible capacity. The positive electrode active material for a fluoride ion battery of the disclosure is iron sulfide. The iron sulfide is preferably iron(II) sulfide or iron disulfide. The fluoride ion battery of the disclosure includes the positive electrode active material of the disclosure. The fluoride ion battery of the disclosure has a positive electrode layer, an electrolyte layer and a negative electrode layer. The positive electrode layer may be constructed of a positive electrode active material layer and a positive electrode collector. The negative electrode layer may be constructed of a negative electrode active material layer and a negative electrode collector.

### FIELD

The present disclosure relates to a positive electrode active material for a fluoride ion battery and to a fluoride ion battery.

### BACKGROUND

PTL 1 discloses an electrochemical cell wherein the anion charge carrier is fluoride ion. The same publication discloses a composition selected from the group consisting of CFₓ, AgFₓ, CuFₓ, NiFₓ, CoFₓ, PbFₓ, CeFₓ, MnFₓ, AuFₓ, PtFₓ, RhFₓ, VFₓ, OsFₓ, RuFₓ and FeFₓ, as the fluoride ion host material.

### CITATION LIST

### Patent Literature

[PTL 1] Japanese Unexamined Patent Publication No. 2013-145758

### SUMMARY

### Technical Problem

There is an ongoing need to reduce the irreversible capacity of fluoride ion batteries.

PTL 1 discloses using iron fluoride or iron (FeFₓ where x=0) as the positive electrode active material. The present inventors have studied how to further reduce irreversible capacity beyond using iron fluoride or iron as the positive electrode active material.

It is an object of the present disclosure to provide a positive electrode active material for a fluoride ion battery, and a fluoride ion battery, having reduced irreversible capacity.

### Solution To Problem

The present inventors have found that the aforementioned object can be achieved by the following means:

### Aspect 1

A positive electrode active material for a fluoride ion battery, the positive electrode active material being iron sulfide.

### Aspect 2

The positive electrode active material according to aspect 1, wherein the iron sulfide is iron(II) sulfide or iron disulfide.

### Aspect 3

A fluoride ion battery comprising a positive electrode active material according to aspect 1 or 2.

### Aspect 4

The fluoride ion battery according to aspect 3, which has a positive electrode layer comprising the positive electrode active material, an electrolyte layer and a negative electrode layer.

### Advantageous Effects of Invention

According to the present disclosure it is possible to provide a positive electrode active material for a fluoride ion battery, and a fluoride ion battery, having reduced irreversible capacity.

### BRIEF DESCRIPTION OF DRAWINGS

FIG. 1 is a graph showing the results of a charge-discharge test for the fluoride ion battery of Example 1.

FIG. 2 is a graph showing the results of a charge-discharge test for the fluoride ion battery of Example 2.

FIG. 3 is a graph showing the results of a charge-discharge test for the fluoride ion battery of Comparative Example 1.

### DESCRIPTION OF EMBODIMENTS

Embodiments of the disclosure will now be described in detail. The disclosure is not limited to the embodiments described below, however, and various modifications may be implemented which do not depart from the gist thereof.

### Positive Electrode Active Material for Fluoride Ion Battery

The positive electrode active material for a fluoride ion battery of the disclosure is iron sulfide.

Iron sulfide is a compound of iron and sulfur, and more specifically it may be iron(II) sulfide (FeS), iron(III) sulfide (Fe₂S₃), iron disulfide (FeS₂) or pyrrhotite. Iron sulfide is generally represented by the general formula FeSₓ, where 0.90×2.00. For iron(III) sulfide, x=1.50.

From the viewpoint of further reducing the irreversible capacity of the fluoride ion battery, iron(II) sulfide (FeS) or iron disulfide (FeS₂) is preferred, and iron(II) sulfide (FeS) is especially preferred.

In a fluoride ion battery using iron sulfide as the positive electrode active material, charge reaction generates simple compounds represented by the formal composition FeSₓF_{y} or a mixture of multiple compounds, with iron sulfide (FeSₓ) being regenerated by discharge reaction.

In a fluoride ion battery using iron as the positive electrode active material, iron fluoride is generated by charge reaction and defluoridation reaction proceeds by discharge reaction, regenerating iron. Inherently high electrical resistance is thought to be generated during these chemical reactions.

In contrast, in a fluoride ion battery using iron sulfide as the positive electrode active material, the electrical resistance generated during defluoridation (discharge) reaction is thought to be lower than when using iron as the positive electrode active material. The difference in electrical resistance is presumably due to the difference in the aforementioned reaction mechanisms.

While the electron conductivity of iron fluoride is low, FeSₓF_{y} is thought to have high electron conductivity on the level of highly conductive FeSₓ.

For these reasons, a fluoride ion battery using iron sulfide as the positive electrode active material has low electrical resistance, thus allowing discharge reaction to proceed efficiently. It is therefore possible to carry out discharge of the charged capacity at high efficiency, i.e. to lower the irreversible capacity.

### Fluoride Ion Battery

The fluoride ion battery of the disclosure comprises a positive electrode active material of the disclosure.

The fluoride ion battery of the disclosure may have a positive electrode layer comprising the positive electrode active material of the disclosure, an electrolyte layer and a negative electrode layer.

The fluoride ion battery of the disclosure may also have a battery case housing the constituent elements.

The fluoride ion battery of the disclosure may be a liquid battery or solid-state battery, and is most preferably an all-solid-state battery. The fluoride ion battery of the disclosure may be either a primary battery or a secondary battery. Examples of battery types for the fluoride ion battery of the disclosure include coin types, laminated types, cylindrical types and rectilinear types.

### Positive Electrode Layer

The positive electrode layer in the fluoride ion battery of the disclosure may be constructed of a positive electrode active material layer and a positive electrode collector.

### Positive Electrode Active Material Layer

The positive electrode active material layer comprises a positive electrode active material, and optionally a solid electrolyte, a conductive aid and a binder.

The positive electrode active material layer comprises a positive electrode active material of the disclosure.

The content of the positive electrode active material in the positive electrode active material layer is preferably higher from the viewpoint of capacity. The mass ratio of the positive electrode active material with respect to the mass of the positive electrode active material layer may be 10 to 90 mass %, and is preferably 20 to 80 mass %.

The solid electrolyte used may be any one mentioned below under <Electrolyte layer>.

The conductive aid is not particularly restricted so long as it has the desired electron conductivity, and examples include carbon materials. Examples of carbon materials include carbon blacks such as acetylene black, Ketchen black, furnace black and thermal black.

The mass ratio of the conductive aid with respect to the mass of the positive electrode active material layer may be 5 to 70 mass %, and is preferably 10 to 40 mass %.

The binder is not particularly restricted, so long as it is chemically and electrically stable, and examples include fluorine-based binders such as polyvinylidene fluoride (PVDF) and polytetrafluoroethylene (PTFE).

The thickness of the positive electrode active material layer is not particularly restricted, and may differ significantly, depending on the battery construction.

The positive electrode active material layer can be formed by accumulating a positive electrode mixture comprising the positive electrode active material and optional solid electrolyte, conductive aid and binder, on the positive electrode collector as the base.

More specifically, the positive electrode active material, and optionally the solid electrolyte, conductive aid and binder, may be mixed with a ball mill to produce a positive electrode mixture powder, and a green compact of the positive electrode mixture powder may be formed on the positive electrode collector. Alternatively, the positive electrode active material and optionally the solid electrolyte, conductive aid and binder may be dispersed in a dispersing medium to produce a slurry, and the slurry may be coated onto the positive electrode collector and dried.

### Positive Electrode Collector

The material of the positive electrode collector is not particularly restricted, so long as it is a material with the desired electron conductivity and does not undergo significant change in volume or shape during charge/discharge, and examples include stainless steel (SUS), aluminum, titanium, iron, nickel, copper, silver, platinum, gold and carbon. The form of the positive electrode collector may be a foil, mesh, pellet or porous form.

### Electrolyte Layer

When the fluoride ion battery of the disclosure is a liquid battery, the electrolyte layer may be composed of an electrolyte solution and optionally a separator, for example.

The electrolyte solution may comprise a fluoride salt and an organic solvent, for example. Examples of fluoride salts include inorganic fluoride salts, organic fluoride salts and ionic liquids. Examples of inorganic fluoride salts include XF (where X is Li, Na, K, Rb or Cs). Examples of cations in organic fluoride salts include alkylammonium cations such as tetramethylammonium cation. The concentration of the fluoride salt in the electrolyte solution may be 0.1 mol % or greater and 40 mol % or lower, for example, and is preferably 1 mol % to 10 mol %.

The organic solvent of the electrolyte solution will usually be a solvent that dissolves the fluoride salt. Examples of organic solvents include glymes such as triethyleneglycol dimethyl ether (G3) and tetraethyleneglycol dimethyl ether (G4), cyclic carbonates such as ethylene carbonate (EC), fluoroethylene carbonate (FEC), difluoroethylene carbonate (DFEC), propylene carbonate (PC) and butylene carbonate (BC), and linear carbonates such as dimethyl carbonate (DMC), diethyl carbonate (DEC) and ethylmethyl carbonate (EMC). An ionic liquid may also be used as the organic solvent.

The separator is not particularly restricted, so long as it has a composition that can withstand the range of use of the fluoride ion battery. Examples for the separator include polymer nonwoven fabrics such as polypropylene nonwoven fabrics and polyphenylene sulfide nonwoven fabrics, and microporous films of olefin-based resins such as polyethylene and polypropylene.

When the fluoride ion battery of the disclosure is a solid-state battery, the electrolyte layer may be a solid electrolyte layer, for example. The solid electrolyte may be any solid electrolyte that can be used in a fluoride ion battery.

Examples of solid electrolytes include fluorides of lanthanoid elements such as La and Ce, fluorides of alkali metal elements such as Li, Na, K, Rb and Cs, and fluorides of alkaline earth elements such as Ca, Sr and Ba. The solid electrolyte may also be a fluoride comprising multiple elements from among lanthanoid elements, alkali metal elements and alkaline earth elements.

Specific examples of solid electrolytes include La₍₁₋ₓ₎BaₓF₍₃₋ₓ₎(0≤x≤2), Pb₍₂₋ₓ₎SnₓF₄(0≤x≤2), Ca₍₂₋ₓ₎BaₓF₄(0≤x≤2) and Ce₍₁₋ₓ₎BaxF₍₃₋ₓ₎(0≤x≤2). The symbol “x” in each formula may be larger than zero, such as 0.3 or greater, 0.5 or greater or 0.9 or greater. The symbol “x” may also be smaller than 1, such as 0.9 or smaller, 0.5 or smaller or 0.3 or smaller.

### Negative Electrode Layer

The negative electrode layer in the fluoride ion battery of the disclosure may be constructed of a negative electrode active material layer and a negative electrode collector.

### Negative Electrode Active Material Layer

The negative electrode active material layer comprises a negative electrode active material, and optionally a solid electrolyte, a conductive aid and a binder.

The negative electrode active material may be selected as any active material having lower potential than the positive electrode active material. Examples of negative electrode active materials include simple metals, alloys, and fluorides of metal oxides. Examples of metal elements for the negative electrode active material include La, Ca, Al, Eu, Li, Si, Ge, Sn, In, V, Cd, Cr, Fe, Zn, Ga, Ti, Nb, Mn, Yb, Zr, Sm, Ce, Mg and Pb. The negative electrode active material is more preferably MgFₓ, AlFₓ, LaFₓ, CeFₓ, CaFₓ or PbFₓ. The symbol “x” is a real number larger than zero.

The content of the negative electrode active material in the negative electrode active material layer is preferably higher from the viewpoint of capacity. The mass ratio of the positive electrode active material with respect to the mass of the positive electrode active material layer may be 10 to 90 mass %, and is preferably 20 to 80 mass %.

The solid electrolyte used may be any one mentioned above under <Electrolyte layer>, while the conductive aid and binder used may be any of those mentioned above under “(Positive electrode active material layer)”.

### Negative Electrode Collector

The material of the negative electrode collector is not particularly restricted, so long as it is a material with the desired electron conductivity and does not undergo significant change in volume or shape during charge/discharge, and examples include stainless steel (SUS), aluminum, titanium, iron, nickel, copper, silver, platinum, gold and carbon. The form of the negative electrode collector may be a foil, mesh, pellet or porous form.

### EXAMPLES

### Examples 1 and 2 and Comparative Example 1

### Example 1

### Fabrication of Positive Electrode Mixture

A ball mill apparatus (Premium Line PL-7 planetary ball mill by Fritsch Co.) was used for mixing and reaction of predetermined amounts of CaF₂ and BaF₂ by mechanical milling, to obtain a powdered Ca_{0.5}Ba_{0.5}F₂ solid electrolyte (50CaF₂·50BaF₂ (mol %)). The ball mill treatment was carried out for 20 hours at 600 rpm in a dry argon atmosphere.

The solid electrolyte, the iron disulfide (FeS₂) as the positive electrode active material and the acetylene black as the conductive aid were mixed by mechanical milling using a ball mill apparatus (Premium Line PL-7 planetary ball mill by Fritsch Co.) to obtain a powdered positive electrode mixture. The ball mill treatment was carried out for 3 hours at 600 rpm in a dry argon atmosphere.

The mixing ratio was: Positive electrode active material:solid electrolyte:conductive aid=37:58:5 (wt %).

### Fabrication of Solid Electrolyte for Electrolyte Layer

Predetermined amounts of LaF₃ and BaF₂ were mixed with a ball mill for a predetermined time period to fabricate La_{0.9}Ba_{0.1}F_{2.9} as a solid electrolyte material for use in a solid electrolyte layer for a battery.

### Fabrication of Fluoride Ion Battery

A green compact for use as a negative electrode active material layer was formed using 50 mg of a mixture of PbF₂ powder as a negative electrode active material and acetylene black powder as a conductive aid. The acetylene black in the mixture was used at 5 wt % with respect to the total mixture.

A green compact was also formed as an electrolyte layer using 150 mg of solid electrolyte powder for an electrolyte layer. As the positive electrode active material layer, a green compact was formed using 15 mg of the positive electrode mixture.

Finally, an aluminum foil as the negative electrode collector, a negative electrode active material layer, a solid electrolyte layer, a positive electrode active material layer and a platinum foil as the positive electrode collector were laminated in that order to fabricate an all-solid-state fluoride ion battery. The diameter of the all-solid-state fluoride ion battery was 11.28 mm.

The all-solid-state fluoride ion battery was then set in a ceramic cylindrical container with an inner diameter of 11.28 mm, and anchored between stainless steel cylinders with a diameter of 11.28 mm from both the negative electrode collector and the positive electrode collector sides.

### Example 2

An all-solid-state fluoride ion battery for Example 2 was fabricated in the same manner as Example 1, except that iron(II) sulfide (FeS) was used as the positive electrode active material.

### Comparative Example 1

An all-solid-state fluoride ion battery for Comparative Example 1 was fabricated in the same manner as Example 1, except that Fe was used as the positive electrode active material.

### Evaluation of Fluoride Ion Batteries

Each of the fluoride ion batteries of the Examples was vacuum pumped in a sealed container while carrying out charge-discharge once at a testing temperature of 200° C. and a current density of 0.1 mA/cm ².

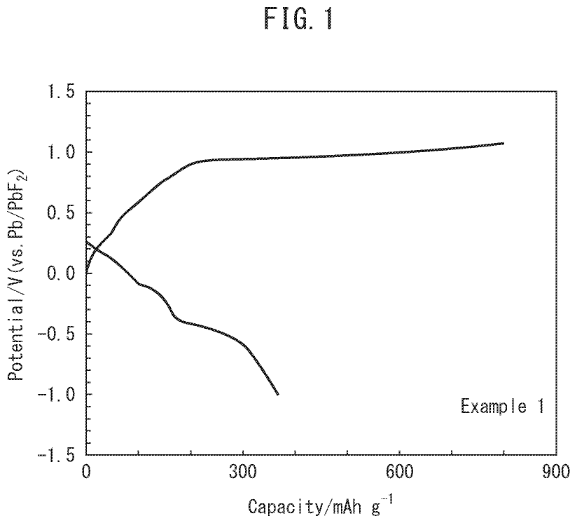

The charge-discharge test results are shown in Table 1 and FIGS. 1 to 3.

TABLE 1

| | Positive | | | Charge- |
|---|---|---|---|---|
| | electrode | Charge | Discharge | discharge |
| | active | capacity | capacity | efficiency |
| | material | (mAh/g) | (mAh/g) | (%) |
| Example 1 | FeS₂ | 800 | 368 | 46.0 |
| Example 2 | FeS | 800 | 605 | 75.6 |
| Comp. Example 1 | Fe | 883 | 355 | 40.2 |

In Table 1, the charge-discharge efficiency (%) values are the ratios of discharge capacity to charge capacity (discharge capacity/charge capacity).

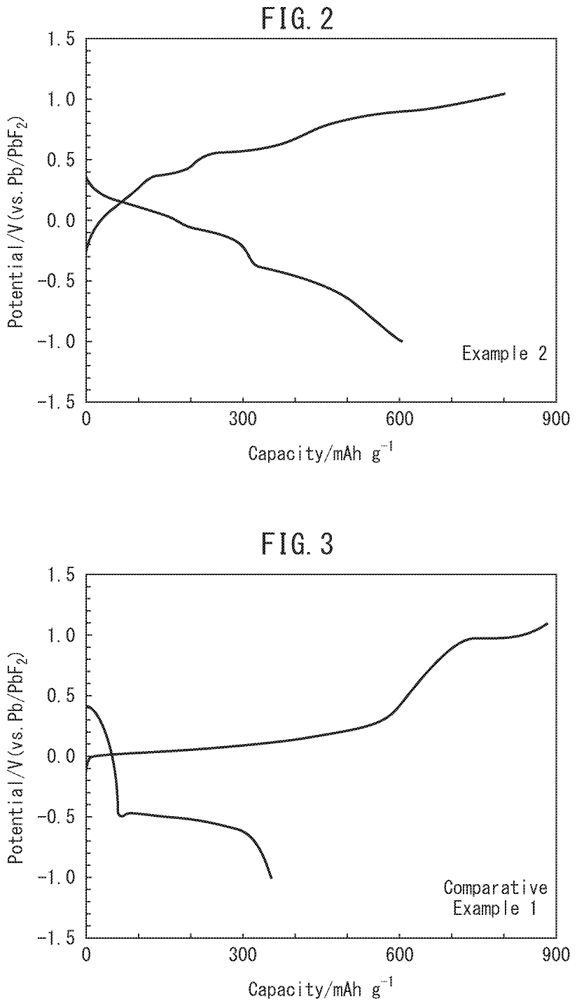

FIG. 1 is a graph showing the results of a charge-discharge test for the fluoride ion battery of Example 1. FIG. 2 is a graph showing the results of a charge-discharge test for the fluoride ion battery of Example 2. FIG. 3 is a graph showing the results of a charge-discharge test for the fluoride ion battery of Comparative Example 1.

As shown in Table 1 and FIGS. 1 to 3, the fluoride ion batteries of Examples 1 and 2 which used iron sulfide had higher charge-discharge efficiency than the fluoride ion battery of Comparative Example 1 which used iron alone.

Among the iron sulfides, the fluoride ion battery of Example 2 which used iron(II) sulfide had higher charge-discharge efficiency than the fluoride ion battery of Example 1 which used iron disulfide.

1. A positive electrode active material for a fluoride ion battery, the positive electrode active material being iron sulfide.

2. The positive electrode active material according to claim 1, wherein the iron sulfide is iron(II) sulfide or iron disulfide.

3. A fluoride ion battery comprising a positive electrode active material according to claim 1.

4. The fluoride ion battery according to claim 3, which has a positive electrode layer comprising the positive electrode active material, an electrolyte layer and a negative electrode layer.

5. A fluoride ion battery comprising a positive electrode active material according to claim 2.
